(19) United States
(12) Patent Application Publication
(10) Pub. No.: US 2005/0012057 A1
(43) Pub. Date: Jan. 20, 2005

(54) Method and apparatus for radiation image erasure

(75) Inventors: Jerel Smith, Boulder Creek, CA (US); Christopher R. Mitchell, Pleasanton, CA (US)

Correspondence Address: HELLER EHRMAN WHITE & MCAULIFFE LLP, 275 MIDDLEFIELD ROAD, MENLO PARK, CA, 94025-3506, US

(73) Assignee: ALARA, INC., Hayward, CA (US)

(21) Appl. No.: 10/842,838

(22) Filed: May 10, 2004

Related U.S. Application Data
(60) Provisional application No. 60/469,465, filed on May 8, 2003.

(51) Int. Cl. G03B 42/08

(52) U.S. Cl. 250/588

(57) ABSTRACT

Methods and device are provided for improved storage screen erasure. A storage screen erasure device comprises a first wavelength source and a second wavelength source. The first wavelength may be selected to pump signal on the screen to be more easily erased by said second wavelength source. The sources may direct energy sequentially onto the screen, it may occur simultaneously, or any combination of the two.

The present application claims the benefit of priority to co-pending U.S. Provisional Patent Application No. 60/469,465 filed on May 8, 2003 which is fully incorporated by reference herein for all purposes.

### BACKGROUND OF THE INVENTION

1. Field of the Invention

This invention relates to radiographic imaging and more specifically to image data related to computed radiography.

2. Description of Related Art

This invention relates to radiographic imaging and more specifically to image data related to computed radiography.

The use of photo-stimulable phosphor image storage screens as a replacement for X-ray film and other sensors is well known. Phosphor image screens work by trapping electrical charge in response to exposure to x-ray radiation. The trapped charge represents a latent image of the x-ray radiation pattern. This latent image can then be read by scanning the storage layer using a suitable wavelength excitation beam, preferably from a focused laser. The laser excitation beam causes the screen to release the trapped electrical charge in the form of emitted stimulable phosphor light that is proportional to the X-ray energy applied to the screen during exposure. The emitted light is collected by an optical system and is converted into an electronic signal proportional to the emitted light. The electrical signal is then converted to a digital value and passed to a computer that generates and stores an image file. The image file can then be displayed as a representation of the original radiograph, with image enhancement software applied to augment the radiographic information.

Latent images stored on a storage layer radiation screen are usually erased prior to placing the storage layer radiation screen back into use. There are a variety of known methods for erasing this latent image. For example, Molecular Dynamics discloses the use of a 500 W photoflood tungsten light bulb and a yellow filter with 10 J/cm² exposure to reduce latent image or residual signal levels to less than 10⁻⁵ of the original exposure level.

Unfortunately, many known methods of erasure are inefficient and have drawbacks that constrain the size, energy consumption, and reliability of the devices used to erase storage layer radiation screens.

### SUMMARY OF THE INVENTION

Accordingly, an object of the present invention is to provide improved storage layer radiation erasing systems, and their methods of use.

Another object of the present invention is to provide improved image erasing techniques which reduces the intensity required to erase an image.

Another object of the present invention is to provide improved image erasing techniques which more thoroughly erases images from a storage medium.

Yet another object of the present invention is to provide improved erasing device and their methods of use, that allow for higher throughput of image storage screens through an erasing device.

Still a further object of the present invention is to provide a storage phosphor system, and the methods of use, that use an improved image erasing scheme.

Another object of the present invention is to integrate an improved erasing assembly with a multiple head storage phosphor system. The integration may result in a single device that moves an image screen inside the device from a read position to an erase position.

At least some of these objects are achieved by some embodiments of the present invention.

In one aspect of the present invention, methods and device are provided for improved storage screen erasure. In one embodiment, a storage screen erasure device comprises a first wavelength source and a second wavelength source. The first wavelength may be selected to pre-excite (“pump”) trapped charge to a state from which it may be more easily removed by a second (“erasing”) wavelength. In another aspect of the present invention, a method for storage screen erasure is provided. The method comprises first exposing the screen to energy at a first wavelength to pump the charge to a more loosely bound state, and second, exposing the screen to energy at a second erasing wavelength to remove the trapped charge. In one embodiment, irradiation by the pumping wavelength occurs prior to irradiation by the erasing wavelength. In another embodiment, irradiation by the pumping wavelength and irradiation by the erasing wavelength occur simultaneously. In still further embodiments, the screen is exposed to energy at a third wavelength. A broadband source may be used in some embodiments. In other embodiments, a single source may be used that has a mix of the pumping wavelength and the erasing wavelength, whose relative intensities and total intensities may be adjusted to optimize erasure for a given embodiment or storage phosphor formulation.

In another embodiment of the present invention, a storage screen erasure device is provided. The device comprises a plurality of LEDs providing energy at a first wavelength and a plurality of LEDs providing energy at a second wavelength. The first wavelength is selected to pump signal on the screen to be more easily erased by the second wavelength source. In one non-limiting example, the first wavelength is about 460 nm and the second wavelength is at about 640 nm.

In yet another embodiment of the present invention, an erasure device is provided which comprises a broadband wavelength source and a narrowband wavelength source at a pumping wavelength. The narrowband wavelength source may be selected to pump signal on the screen to be more easily erased by the broadband.

Finally, another embodiment might involve the adjustment of overall intensity, and/or the relative intensities of the multiple wavelengths, and/or the time duration that the storage phosphor imaging plate is exposed to the erasing light.

A further understanding of the nature and advantages of the invention will become apparent by reference to the remaining portions of the specification and drawings.

### BRIEF DESCRIPTION OF THE DRAWINGS

FIG. 1 shows the stimulation spectrum an image storage screen.

FIGS. 2 and 3 show the output of various energy sources.

FIGS. 4 and 5 show perspective and cross-sectional views of one embodiment of an erasure device according to the present invention.

FIG. 6 is a cross-sectional view of a further embodiment according to the present invention.

FIGS. 7-9 show other embodiments of energy sources according to the present invention.

FIGS. 10-12 show the order of energy source exposure according to the present invention.

### DESCRIPTION OF THE SPECIFIC EMBODIMENTS

It is to be understood that both the foregoing general description and the following detailed description are exemplary and explanatory only and are not restrictive of the invention, as claimed. It should be noted that, as used in the specification and the appended claims, the singular forms “a”, “an” and “the” include plural referents unless the context clearly dictates otherwise. Thus, for example, reference to “a material” may include mixtures of materials, reference to “an LED” may include multiple LEDs, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for analyzing a blood sample, this means that the analysis feature may or may not be present, and, thus, the description includes structures wherein a device possesses the analysis feature and structures wherein the analysis feature is not present.

The excitation spectrum associated with storage image screens such as, but not limited to, storage phosphor, may be quite broad. In general, the broad smooth excitation spectrum will have one or more excitation lines or specific wavelengths in the broad curve. In one aspect, the present invention describes the use of different excitation/erasure wavelengths within that spectrum, other than those centered on the red, to erase latent images. In another aspect, the present invention describes the combination of different wavelengths for erasure of latent images. In a still further aspect, the present invention describes the sequential use of different wavelengths to erase a latent image.

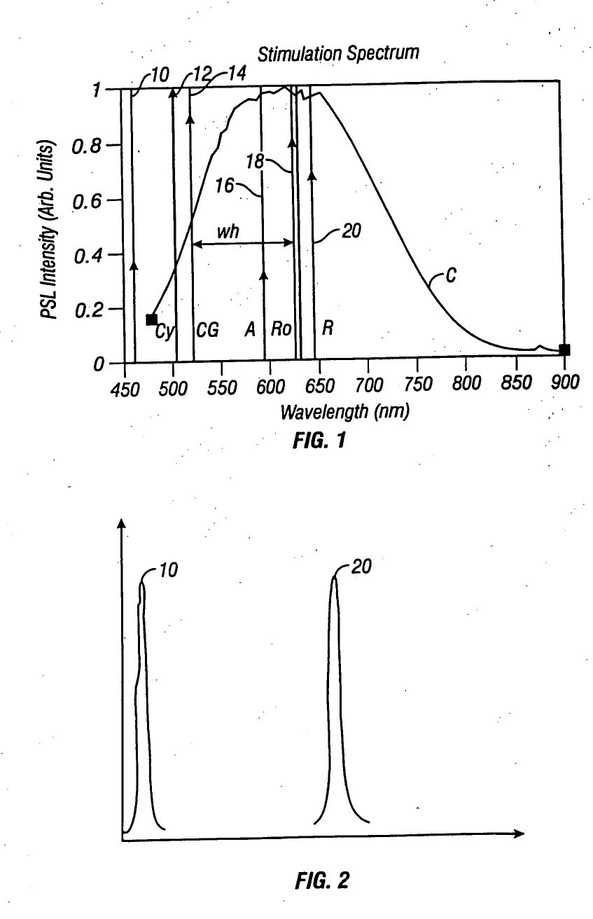

Referring now to FIG. 1, a graph is presented that shows the stimulation spectrum for one embodiment of an image storage screen. In this particular embodiment, the spectrum is for a phosphor image screen which is barium based, with some strontium. The X-axis on the chart corresponds to stimulation wavelength while the Y-axis shows photo-stimulated luminescence (PSL) intensity. The curve C shows the intensity of emitted light when the screen is stimulated at different wavelengths. Lines 10, 12, 14, 16, 18, and 20 correspond to wavelengths about which various LEDs may be centered. Of course, LEDs with wavelengths centered about other wavelengths may also be used with the present invention.

Referring now to FIG. 2, one embodiment of the present invention may use a plurality of wavelength sources to provide stimulation energy at specific wavelengths. It has been shown in the present invention that exposure of a storage screen to energy at a first (i.e. pumping) wavelength and then to energy at a second wavelength (i.e. the erasing wavelength) results in improved erasing efficiency as compared to the same total intensity at the erasing wavelength alone, for the same exposure time. As a non-limiting example, a phosphor image screen such as but not limited to that whose excitation spectrum is shown in FIG. 1 can achieve a higher erasure quality by first exposing the screen to energy at a blue visible wavelength centered at about 460 nm shown as position 10 in FIG. 2. The screen is then exposed to energy at the erasure wavelength of 640 nm at position 20. The exposure to blue visible light pumps or excites the phosphor screen to an excitation state where trapped charge is more thoroughly erased by light or energy at the erasure wavelength.

In some embodiments, rather than sequentially exposing the image plate to the pumping wavelength and then to the erasing wavelength, both wavelengths may be applied simultaneously (see FIG. 11). It should be understood, that in some further embodiments, three or more wavelengths may be used singly, in pairs, in other numbers, and may be applied in any combination of sequential or simultaneous exposures. In other embodiments, wavelengths different from those described above may also be used. In one non-limiting example, the first wavelength may be in the range of 400 to 640 nm while the second wavelength may be in the range of 600 nm and longer.

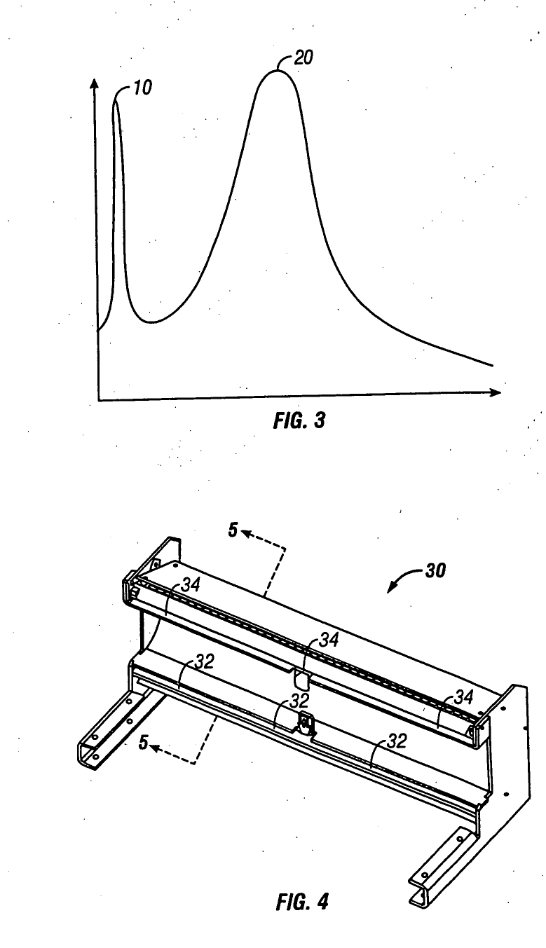

Referring now to FIG. 3, the graph of one embodiment of a broadband wavelength source having a tailored output is shown. The output has peaks at positions 10 and 20 which correspond to the pump and erasure wavelengths for a phosphor screen as described above. The broadband wavelength source may include, but is not limited to, an image eraser lamp such as, but not limited to, a tungsten light bulb. The lamps or bulbs may be used with various filters to create the desired output. Lamps or even broadband LEDs may also be manufactured to have specific output profiles.

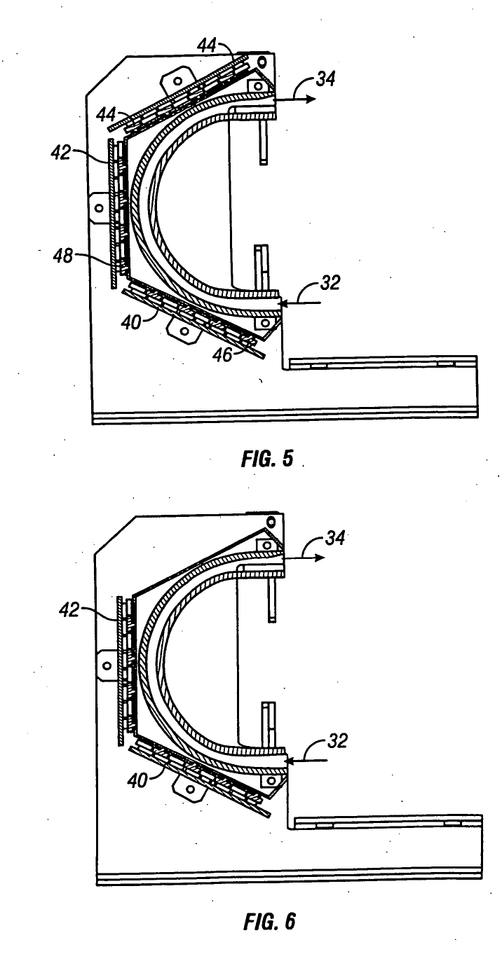

Referring now to FIGS. 4 and 5, one embodiment of a device 30 according to the present invention will be described. FIG. 4 shows a perspective view of an erasing device 30 where an imaging screen would enter as indicated by arrows 32 and exit as indicated by arrows 34. The device 30 may be coupled to a phosphor image reader device as disclosed in U.S. Pat. Nos. 6,268,613 and 6,355,938 fully incorporated herein by reference (for the PCT guys, why can't we incorporate the PCT applications by reference as well, and obviate the need to include the patents (verbatim) in this application?). As seen in FIG. 5, a plurality of printed circuit boards (PCBs) 40, 42, and 44 may have installed LEDs 46, 48, and 50. In one non-limiting example, the PCB 40 includes LEDs of one color such as but not limited to, blue. This PCB 40 with the. blue LEDs will pump the stored charge to be more easily removed by the light from the LEDs mounted on the next PCB (42). The PCB 42 includes a plurality of LEDs in the red wavelength. This PCB 42 emits energy that will erase the signal that has been pumped up by the blue-emitting LEDs on PCB 40. In one embodiment, the third PCB 44 may have mounted additional red LEDs to provide further erasing capability. In some further embodiments, each PCB 40, 42, and 44 may have LEDs of different wavelengths. Some embodiments may have two pumping boards and one erasing board. Still further embodiments may have at least one board where at least some of the LEDs are at a first wavelength while at least some of the other LEDs are at a second wavelength. Such a board may also include a third or higher number of wavelengths. It should also be understood that at least one of these boards may be replaced by a lamp or other broadband source and used in conjunction with sources such as but not limited to, LEDs which produce energy over specified wavelengths.

Referring now to FIG. 6, yet another embodiment of the device 30 may include only two PCBs 40 and 42. In one non-limiting example, PCB 40 produces a pumping wavelength while the PCB 42 produces an erasing wavelength. Each of these wavelengths may be selected based on the type of storage screen being used. Some plates are stimulated in the infrared and emit in the green. So, the wavelengths for pumping and erasure may be dependent on the particular storage phosphor material used.

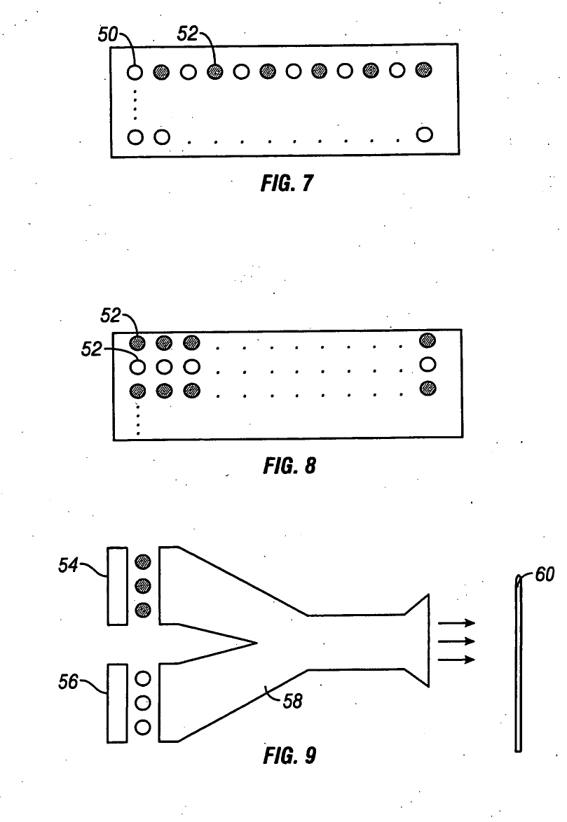

Referring now to FIG. 7, one configuration of a board is shown where LEDs 50 of a first wavelength are shown with a hollow circle while LEDs 52 of a second wavelength are shown with a solid circle. In this embodiment, the LEDs may be distributed in an alternating pattern. This configuration supports an embodiment wherein the storage phosphor imaging plate is simultaneously exposed to pumping and erasing wavelengths.

Referring now to FIG. 8, another configuration of a board shows an entire row of LEDs 50 and another row of LEDs 52. These may be in alternating rows, rows of one type of LEDs followed by a single row of the other type of LED, or any combination of rows.

Referring now to FIG. 9, a still further embodiment shows boards or wavelength sources 54 and 56 joined by an optical coupler 58. Each board or source provides a different wavelength. They may be flashed in a sequence, activated simultaneously, or any combination of the above to provide pumping and erasing energy to an imaging plate 60.

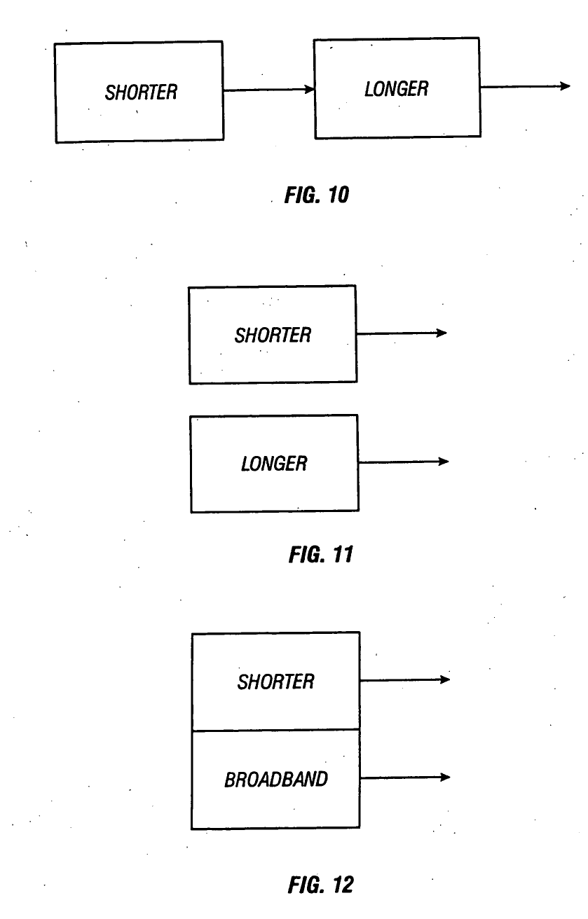

FIGS. 10 through 12 show various combinations of the sequence of the energy sent to the imaging plate. FIG. 10 shows a combination where the shorter wavelengths are used first, followed by longer wavelengths. FIG. 11 shows that shorter and longer wavelengths are used simultaneously. FIG. 12 shows a shorter wavelength source used simultaneously with a broadband wavelength source. In a still further embodiment, a energy source providing energy at a pumping wavelength for a specific screen material may be used in conjunction with a broadband source. Any of the combinations above may be used singly, in pairs, in other numbers, in sequence, simultaneously, or in any combination of the above to provide signal erasure.

It should be understood that the pumping wavelength, in one embodiment, may be in the blue, violet, and ultraviolet wavelengths. For the erasing wavelength, longer wavelengths ranging from green through infrared may be used. Accordingly, although one embodiment uses a 460 nm source for pumping and a 640 nm source for erasure, a variety of wavelengths maybe used such as but not limited to: 500 to 400 nm for pumping and 600 to 750 nm or longer wavelengths for erasure.

Embodiments of the present invention may also comprise one board having all of the pumping and erasure light sources on the same board. These light sources may also be, but are not necessarily, arranged on the board in some pattern such as but not limited to circles, polygons, triangles, squares or other shape as may be useful for extracting trapped charge from the imaging plate. In one embodiment, the present invention provides improved erasure and can provide a throughput of X meters per second due to the erasing efficiency of the combined wavelengths. Throughput may also be quantified as processing X image storage screens of size Y per minute. Such screen rates can be found with reference to the device shown in U.S. Pat. No. 6,268,613 or U.S. patent application Ser. No. 09/847,857 (Attorney Docket No. 39315-0050) filed May 1, 2001. All applications and patents listed herein are incorporated herein by reference for all purposes. Known erasing systems may be able to achieve such an erasing efficiency, but would either need to move more slowly past the bank of eraser lights, require greater eraser intensity with the additional heat, or require larger banks of eraser lights.

LEDs are convenient to use in embodiments of the present invention since they require low voltage and are easy to implement. Silicon devices may also be used.

Embodiments of the present invention have been shown to provide up to a 50,000:1 erasure ratio. For single wavelength erasure schemes with similar total intensity, erasure ratios of 10,000:1 or less are typical. Depending on the design tradeoffs that are made, the present invention can efficiently achieve essentially any desired depth of erasure.

Moreover, embodiments of the present invention have been shown to provide equivalent erasure for much less heat compared to erasure mechanisms that are extant.

The mounting means for the erasure lights may also be configured to be moveable, such as but not limited to, being on a track, pulley, conveyor system, or other moving device to move the erasure lights past the imaging plate. In some embodiments, the screen may remain stationary while the eraser assembly is moved. In other embodiments, the eraser assembly is stationary and the image plate is moved. In still further embodiments, both the erasure assembly and the image plate are in motion. Optical trains using prisms, splitters, mirrors, movable mirrors, rotating mirrors, or the like may also be used to disperse energy over desired areas of the screen.

A number of different preferences, options, embodiment, and features have been given above, and following any one of these may results in an embodiment of this invention that is more presently preferred than a embodiment in which that particular preference is not followed. These preferences, options, embodiment, and features may be generally independent, and additive; and following more than one of these preferences may result in a more presently preferred embodiment than one in which fewer of the preferences are followed. In some embodiments, the ratio of pumping wavelength intensity to erasing wavelength intensity is 50/50, while in others the ratio of pumping to erasure may be 40/60, 60/40, or the like. The present invention may also be adjusted to provide erasing quality from at least 10000:1, 15000:1, 20000:1, 25000:1, 30000:1, 35000:1, 40000:1, and/or 45000:1

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. Any of the embodiments of the invention may be modified to include any of the features described above or feature incorporated by reference herein. For example, the wavelength sources at specific wavelengths may be combine with other erasure schemes as known in the art. Intermediate bands, triple combinations, or other ways of producing spectra instead of LEDs may also be used. Single sources may be designed to have tailored spectrums which provide both a pumping wavelength and an erase wavelength. The size of the boards may also vary. In on embodiment, it may be 2.5-3 inches wide. LEDs on the boards can also be interspersed, with LEDs of different wavelengths on the same board. Colored wavelengths with at least one broadband source. They may be used in combination in a specified sequence (where one of the sources is broadband such as but not limited to a broadband LED or other silicon device). Some embodiments of the present invention may also direct pump wavelength and erasure wavelength energy to the same screen and that energy may be directed to the same positions on the screen or to different positions of the same screen. In any of the above embodiments, the wavelength sources may direct energy sequentially onto the screen, it may occur simultaneously, or any combination of the two. Although the present application describes the present invention context of phosphor image screens, it should be understood that the present invention may be used with other image screens or other storage devices.

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited.

Expected variations or differences in the results are contemplated in accordance with the objects and practices of the present invention. It is intended, therefore, that the invention be defined by the scope of the claims which follow and that such claims be interpreted as broadly as is reasonable.

1. A method for erasing an image on an image storage screen, said method comprising:
exposing the screen to energy at a pumping wavelength, wherein said pumping wavelength is in the visible spectrum; and
exposing the screen to energy at an erasing wavelength different from said pumping wavelength.

2. The method as in claim 1 wherein the screen is exposed to the pumping wavelength before being exposed to the erasing wavelength.

3. The method as in claim 1 comprising simultaneously exposing different areas of the same screen to the pumping wavelength and the erasing wavelength.

4. The method as in claim 1 comprising simultaneously exposing one area on the screen to pumping wavelength and erasing wavelength.

5. The method as in claim 1 comprising exposing the screen to energy at a third wavelength.

6. The method as in claim 1 comprising using a broadband wavelength source to provide at least one of the following: the pumping wavelength, the erasing wavelength, or both the pumping and erasing wavelengths.

7. The method as in claim 1 wherein the pumping wavelength is outside the ultraviolet spectrum.

8. The method as in claim 1 wherein the pumping wavelength is between about 400 nm and 640 nm.

9. The method as in claim 1 wherein the erasing wavelength is longer than 600 nm.

10. The method as in claim 1 comprising using a single energy source having an energy output that is weighted to provide greater energy intensity at both the pumping wavelength and at the erasing wavelength.

11. The method as in claim 1 comprising erasing the screen to a ratio from 50000 counts before erasing to 1 count after erasing.

12. The method as in claim 1, wherein the desired erasing depth may be selected by changing the duration of the exposure of the imaging plate to the pumping and erasing wavelengths.

13. The method as in claim 1 wherein the desired erasing depth may be selected by choosing the relative intensities of the pumping and erasing wavelengths.

14. The method as in claim 1 wherein the desired erasing depth may be selected by choosing the total intensity of the pumping and erasing wavelengths.

15. The method as in claim 1 further comprising using a multiple head device to read the image prior to erasure.

16. The method as in claim 1 further comprising transporting the screen along a path having at least one curved portion, said path moving the screen past a reader and then to an erasing assembly that performs the erasing steps.

17. The method as in claim 1 further comprising transporting the screen along a path in a readout and erase device, said path having at least one curved portion and moves the screen from a top side of the device to an underside of the device.

18. A storage screen erasure device comprising:
a first wavelength source;
a second wavelength source;
wherein said first wavelength is selected to pump signal on the screen to be more easily erased by said second wavelength source and wherein said first wavelength source is in the visible spectrum; and
a controller having logic to activate the sources to erase images from the storage screen.

19. The device of claim 18 wherein the first wavelength source and the second wavelength source comprise a plurality of LEDs.

20. The device of claim 18 wherein the first and second source comprise LEDs on separate boards.

21. The device of claim 18 wherein the first and second source comprise LEDs on the same board.

22. The device of claim 18 wherein said first wavelength is about 460 nm and said second wavelength is at about 640 nm.

23. The device of claim 18 wherein said first wavelength is greater than about 400 nm but less than said second wavelength, wherein said second wavelength is greater than about 600 nm.

24. An integrated device comprising:
a multiple head image screen scanner for extracting an image stored on said image screen;
an image erasure device of claim 18 coupled to said scanner; and
an image screen conveyor systems configure to move said image screen in manner so that the image screen is first read by the scanner and then moves along the feeder to the erasure device.

25. A device comprising:
a broadband wavelength source;
a narrowband wavelength source at a pumping wavelength
wherein said narrowband wavelength source is selected to pump signal on the screen to be more easily erased by said broadband.

26. A method for making a radiography device using an image storage screen, said method comprising:
providing a first wavelength source;
providing a second wavelength source;
wherein said first wavelength is selected to pump signal on the screen to be more easily erased by said second wavelength source;
coupling said first wavelength source and a second wavelength source to housing with a device for reading signals from said screen.

27. The method as in claim 26 comprising providing a screen transfer device that can provide a throughput of X screens of size Y per minute.

28. The method as in claim 26 wherein said first wavelength source and said second wavelength source are at wavelengths outside a wavelength used to read signal from the screen.

29. The method as in claim 26 further comprising providing an optical coupler to direct light from the first wavelength source and the second wavelength source to the same location on the screen.

30. The method as in claim 26 providing a third wavelength source.

31. The method as in claim 26 wherein said first wavelength source and second wavelength source provide an erasure ratio of 50000 to 1.

32. The method as in claim 26 wherein said first wavelength source and second wavelength source comprise a plurality of LEDs.

33. The method as in claim 26 wherein an image erase device is coupled to one end of an image screen reading device.

34. The method as in claim 26 further comprising providing a shield positioned to prevent light from erase device from reaching an image readout area.

35. The method as in claim 26 further comprising providing at least one of the following for the first or second wavelength source: an LED, a laser, a laser diode, or a lamp.
